(19) United States
(12) Patent Application Publication
(10) Pub. No.: US 2009/0238205 A1
(43) Pub. Date: Sep. 24, 2009

(54) METHODS AND APPARATUSES FOR TRANSMITTING SUA SIGNALING NETWORK MANAGEMENT MESSAGE

(75) Inventors: Haifeng Wang, Shenzhen (CN); Zhuohui Lei, Shenzhen (CN); Jingli Shao, Shenzhen (CN); Zongrong Zhou, Shenzhen (CN)

Correspondence Address: Huawei Technologies Co., Ltd.;c/o Darby & Darby P.C., P.O. Box 770, Church Street Station, New York, NY, 10008-0770, US

(73) Assignee: Huawei Technologies Co., Ltd., Shenzhen (CN)

(21) Appl. No.: 12/479,560

(22) Filed: Jun. 5, 2009

Related U.S. Application Data
(63) Continuation of application No. PCT/CN2007/070550, filed on Aug. 24, 2007.

(30) Foreign Application Priority Data
Dec. 7, 2006 (CN) 200610157351.9

(51) Int. Cl. H04L 29/06

(52) U.S. Cl. 370/467

(57) ABSTRACT

A method for transmitting an SUA signaling network management message includes: upon the determination that the received signaling network management message is an SUA signaling network management message and the signaling point with a changed state is an IP signaling point according to the address information in the SUA signaling network management message, storing the changed state information of the IP signaling point locally at the first SUA relay; converting the SUA signaling network management message into an SCCP signaling network management message upon the determination that the sub-networks connected with the first SUA relay include at least one traditional telecommunication signaling network, and transmitting the SCCP signaling network management message to the at least one traditional telecommunication signaling network. The method enables the traditional telecommunication signaling network to learn the changed state information of the IP signaling point after the state of the IP signaling point on the IP signaling network side of the SUA relay is changed. Embodiments of the present disclosure also disclose an SUA relay.

### CROSS REFERENCE

The present application claims the priority of Chinese patent application No. 200610157351.9, entitled “METHODS AND APPARATUSES FOR TRANSMITTING SUA SIGNALING NETWORK MANAGEMENT MESSAGE” filed with the State Intellectual Property Office on Dec. 7, 2006, the content of which is herein incorporated by reference in its entirety.

### FIELD OF THE INVENTION

The present disclosure generally relates to the field of communication, and more particularly, relates to methods and apparatuses for transmitting a Signaling Connection Control Part User Adaptation Layer (SUA) signaling network management message.

### BACKGROUND

Because a traditional telecommunication signaling network, such as a No. 7 signaling network, is a narrowband network based on fixed links, its signaling is transmitted over the signaling link having a fixed rate. As the continuous increasing of user size and the constant developing of value-added services, the burden for the traditional telecommunication signaling network is progressively heavier, causing the bandwidth problem and device stability becoming increasingly significant. Therefore, packaging becomes a major trend for the current network development, in which case Internet Protocol (IP) signaling network arises.

IP signaling network refers to a network that transmits signaling messages based on the IP protocol as the bearer technique. The general signaling message refers to a message achieving the calling control and the related service function. In an IP signaling network, the Signaling Transport (SIGTRAN) protocol family based on the IP technique includes an adaptation protocol for the No. 7 signaling system Message Transfer Part (MTP) layer, for providing the ability of transmitting the No. 7 signaling over the IP signaling network. Thus, the No. 7 signaling message that is widely employed in the traditional telecommunication signaling network, such as the Signaling Connection Control Part (SCCP) signaling network management message, may also be efficiently and reliably transmitted in the IP signaling network, enabling the communication between the IP signaling network and the traditional telecommunication signaling network; in addition, the IP signaling network may further include an adaptation protocol SUA, which is adapted with the traditional telecommunication signaling network SCCP layer for providing an enhanced address mapping and routing function, as well as more simple management function. For the signaling gateway, the SUA side refers to the IP signaling network side, and the SCCP side refers to the traditional telecommunication signaling network side.

Networking of a typical IP signaling network is as illustrated in FIG. 1, wherein the SUA supports the transmission of No. 7 signaling messages over the IP signaling network 11. The SUA supports message transmissions between a signaling gateway (SG) 13 and an IP signaling point (not shown, such as an IP address database), as well as between two signaling points within the same IP signaling network 11. The signaling gateway 13 is responsible for the signaling communication between the No. 7 signaling network SCCP layer (not shown) and the IP signaling network SUA layer (not shown). When the signaling gateway 13 receives a message sent from the No. 7 signaling network SCCP layer, it performs address conversion and address mapping processing to convert this message into a corresponding SUA signaling network management message, and transmits it to a specified SUA destination signaling point on the IP signaling network 11; when the signaling gateway 13 receives a SUA signaling network management message sent from the IP signaling network 11, it performs address conversion and address mapping processing and routes the processed SUA message to a No. 7 destination signaling point on the No. 7 signaling network 12.

In related art, a No. 7 signaling message such as the SCCP message or MTP message generated when the state of a signaling point or an SCCP user in the No. 7 signaling network is changed, may be converted into a corresponding SUA signaling network management message through the signaling gateway, and be sent to the related SUA signaling points on the IP side timely, to ensure that the SUA signaling points may learn this situation in time.

The IP signaling network application scene as illustrated in FIG. 2 exists widely in the 3rd Generation Mobile Communication System (3G) technical field. In FIG. 2, a first IP network 1 and a second IP network 2 are connected via an SUA relay 20, which is equivalent to an SG described in the SUA protocol while communicating with the traditional telecommunication signaling network and the IP signaling network, and an IP signaling point is equivalent to the SUA signaling point described in the SUA protocol. Thus, when the state of an IP signaling point 21 in the first IP network 1 is changed, an SUA relay 20 on the first IP network 1 side detects this situation (e.g., by receiving an SUA signaling network management message or a state maintenance message sent from the IP signaling point 21 in the network 1, and it being illustrated below by an example of the SUA signaling network management message), it should send the corresponding signaling network management message to the related signaling point connected thereof on the other side, such as the SUA relay 20 on the second IP network 2 side or an IP signaling point 22 in the second IP network 2, to inform the signaling points of the state changing of the IP signaling point 21 in the first IP network 1, so as to ensure that these related signaling points may adjust the service traffics timely according to the state indication within the SUA signaling network management message, thereby maintaining the service traffic in the entire network in a proper state. In other words, the network is intend to implement the following function: the SUA relay may receive the SUA signaling network management message from the IP side and forward it, with the information of related signaling point carried in the SUA signaling network management message identifying the IP signaling point.

However, in the related art above, the parameters for related signaling point in the SUA signaling network management message may be presented in manner of a point code, that is, the default related signaling point in the current SUA protocol may be the signaling point on the SCCP side only, i.e., the No. 7 signaling point. Thus, for the SUA relay, when the networks connected on its both sides are IP signaling network and No. 7 signaling network respectively, the SCCP signaling network management message can be triggered only on the SCCP side and sent to the SUA side by the SUA relay. In other words, when the state of a No. 7 signaling point is changed, the SCCP signaling network management message may be transmitted from the No. 7 signaling network to the IP signaling network in one-way; while the state of an IP signaling point in the IP signaling network is changed, the No. 7 signaling point in the No. 7 signaling network is unable to receive the SUA signaling network management message related to this IP signaling point, thus unable to learn the changed state of the IP signaling point.

### SUMMARY

Embodiments of the present disclosure provide methods and apparatuses for transmitting an SUA signaling network management message, thus when a state of an IP signaling point in the IP network on one side of the SUA relay is changed, the traditional telecommunication signaling network on the other side may learn the state information of the IP signaling point with a changed state.

Embodiments of the present disclosure provide the following technical schemes:

A method for transmitting an SUA signaling network management message in a communication network including a first SUA relay connected with at least two sub-networks is provided, where the at least two sub-networks include at least one traditional telecommunication signaling network and at least one IP signaling network. The method includes:

determining, according to address information in an SUA signaling network management message, whether a network signaling point with a changed state is an IP signaling point when the first SUA relay receives the SUA signaling network management message sent from a sub-network connected with the first SUA relay; and

when the sub-networks connected with the first SUA relay include at least one traditional telecommunication signaling network, converting the SUA signaling network management message into an SCCP signaling network management message and transmitting the SCCP signaling network management message to at least one No. 7 signaling point in the at least one traditional telecommunication signaling network.

An SUA relay includes

a receiving module, configured to receive a signaling network management message sent from a sub-network connected with the SUA relay, the signaling network management message indicating state changing of a network signaling point with a changed state;

a determining module, configured to determine whether the network signaling point with the changed state is an IP signaling point according to address information in the signaling network management message if the signaling network management message is an SUA signaling network management message;

an analyzing module, configured to determine whether sub-networks connected with the SUA relay include a traditional telecommunication signaling network according to the determination information of the determining module;

a converting module, configured to convert the SUA signaling network management message into an SCCP signaling network management message if the analyzing module indicates that the sub-networks connected with the SUA relay include at least one traditional telecommunication signaling network; and

a transmitting module, configured to forward the SCCP signaling network management message obtained by the converting module to a No. 7 signaling point in the at least one traditional telecommunication signaling network.

An SUA relay includes:

a module configured to detect whether a state of an IP signaling point connected directly with the SUA relay is changed;

a module configured to generate an SUA signaling network management message upon detecting that the state of the IP signaling point connected directly with the SUA relay is changed, the signaling network management message indicating state changing of the IP signaling point with the changed state;

a module configured to analyze whether sub-networks connected with the SUA relay include a traditional telecommunication signaling network;

a module configured to convert the SUA signaling network management message into an SCCP signaling network management message if the sub-networks connected with the SUA relay include at least one traditional telecommunication signaling network; and

a module configured to forward the SCCP signaling network management message to a signaling point in the at least one traditional telecommunication signaling network.

An embodiment of the present disclosure provides a method for transmitting an SUA signaling network management message, enabling the traditional telecommunication signaling network to learn the changed state information of the IP signaling point after the state of the IP signaling point on the IP signaling network side is changed.

An SUA relay provided by another embodiment of the present disclosure may converts the SUA signaling network management message on the IP side into a corresponding SCCP signaling network management message, so as to ensure that when the state of an IP signaling point in an IP signaling network is changed, the No. 7 signaling points in a traditional telecommunication signaling network connected with the IP signaling network via the SUA relay may adjust the service traffics timely according to the state indication in the converted SCCP signaling network management message, thereby maintaining the service traffic in the entire network in a proper state.

### BRIEF DESCRIPTION OF THE DRAWING(S)

FIG. 1 is a networking schematic diagram of a typical IP signaling network of related art;

FIG. 2 is a schematic diagram of application of the prior art IP signaling network in 3G technical field;

FIG. 3 is a schematic block diagram of an extended DAVA message in an embodiment of the present disclosure;

FIG. 4 is a schematic diagram of one application of embodiments of the present disclosure;

FIG. 5 is a flowchart of a method for transmitting an SUA signaling network management message according to an embodiment of the present disclosure;

FIG. 6 is a schematic block diagram of an SUA relay according to an embodiment of the present disclosure; and

FIG. 7 is a schematic block diagram of the converting module in FIG. 6.

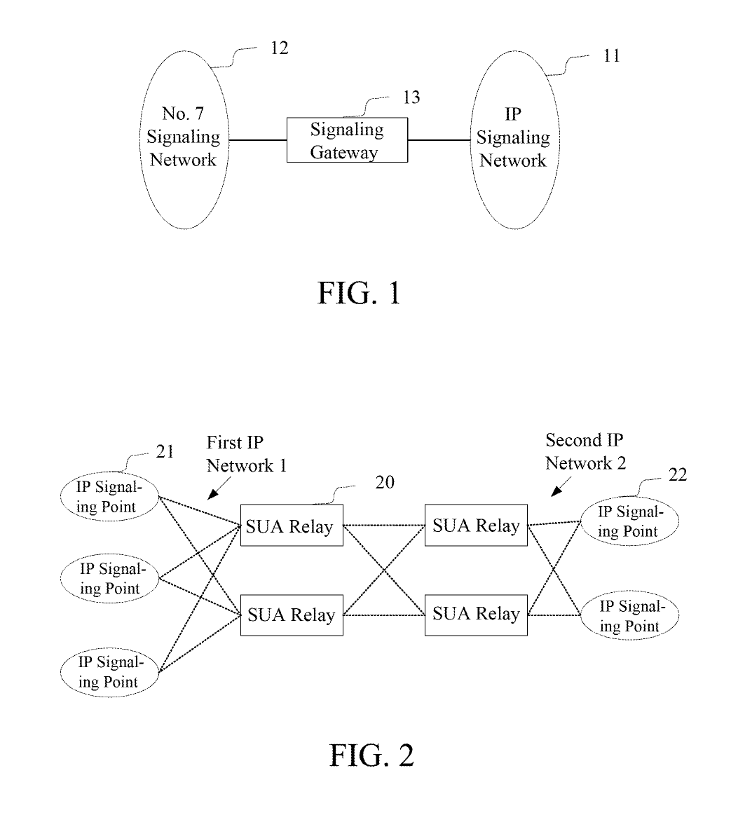

### DETAILED DESCRIPTION

In an embodiment of the present disclosure the address information of the IP signaling point is set with a changed state in the SUA signaling network management (SNM) message, the local stored state information of the IP signaling point is updated with a changed state according to the SUA signaling network management message at the SUA relay locally, the SUA signaling network management message is converted into a corresponding SCCP signaling network management message if the node connected with the SUA relay on the other side is a No. 7 signaling point, and the message is transmitted to the No. 7 signaling point, and the No. 7 signaling point is enabled to learn the changed state information of the IP signaling point.

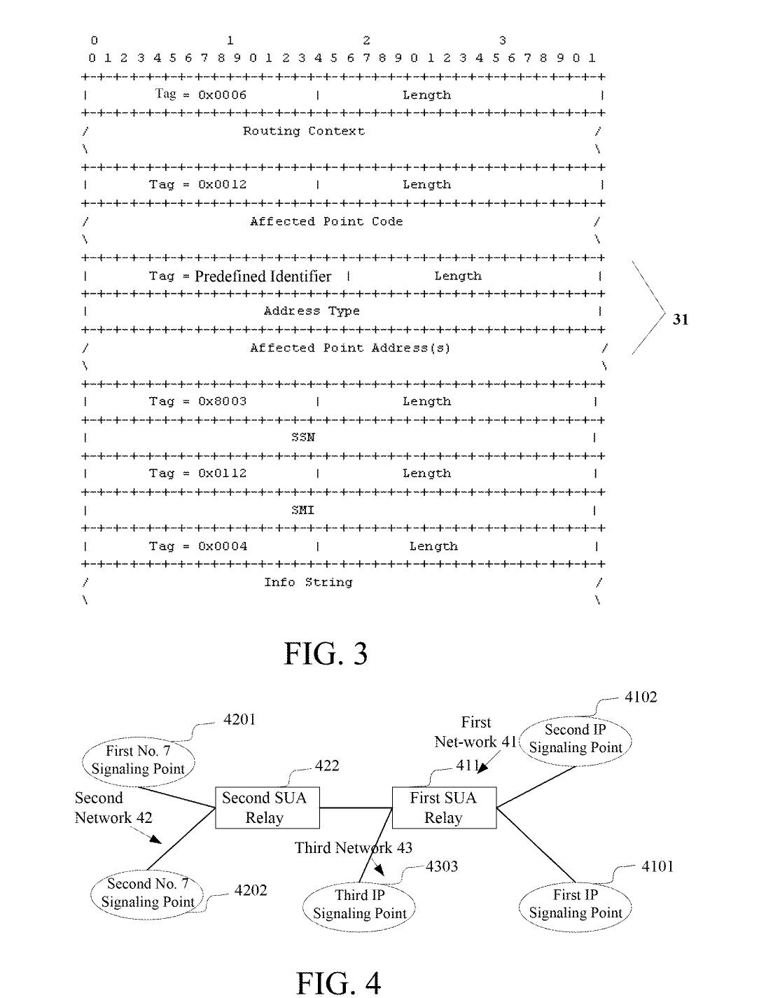

FIG. 3 discloses a structure of a Destination Available (DAVA) message configured with the address information of the IP signaling point in an embodiment of the present disclosure. The DAVA message is one of the SUA signaling network management messages. As compared with the existing DAVA message, the DAVA message in this embodiment is added with an Affected Point Address parameter 31, i.e., the affected signaling point address parameter or which may be referred to as the address parameter of the signaling point with a changed state, for representing the address of the IP signaling point with a changed state.

The Affected Point Address parameter 31 further includes Address Type information, for discerning the type of the IP signaling point with a changed state. The type of an IP signaling point may be one of IPV4, IPV6, hostname, etc.

The Affected Point Address parameter 31 further includes a Tag, the value of which may be defined as desired, provided that the type of the Affected Point Address parameter may be identified uniquely, that is, this parameter is distinguishable from other parameters, such as a Routing Context parameter, etc.

The length in the Affected Point Address parameter 31 has the same meaning as the length in other parameters, such as the Routing Context parameter.

The DAVA message in the embodiment of the present disclosure includes both the Affected Point Code parameter and Affected Point Address parameter 31, where the Affected Points in both of the parameters refer to the same signaling point, i.e., the signaling point with a changed state.

An embodiment of the present disclosure sets the Affected Point Address parameter 31 in an extended field of the DAVA. The position of this parameter is not limited to that depicted in FIG. 3, and may be at any position in the message. However, it is suggested that the parameter is located after the general message header and prior to the Information String parameter. In addition, the field allocated to another parameter (except the Affected Point Code parameter) may be re-allocated to the Affected Point Address parameter 31.

In the prescription of the existing protocols, all the parameters in the DAVA message are optional, except the Affected Point Code parameter. Therefore, the DAVA message configured with the IP signaling point address information in the embodiment of the present disclosure may be transmitted normally in the IP signaling network, without the problem of incompatibility.

FIG. 3 depicts the structure of the DAVA configured with the IP signaling point address information. However, the configuration rule is also applicable to other types of SUA signaling network management messages, such as the Destination Unavailable (DUNA) message, the Destination User Part Unavailable (DUPU) message, the Signaling Congestion (SCON) message, or the Destination Restricted (DRST) message. It is apparent that such configuration may be readily implemented, and thus will not be detailed here.

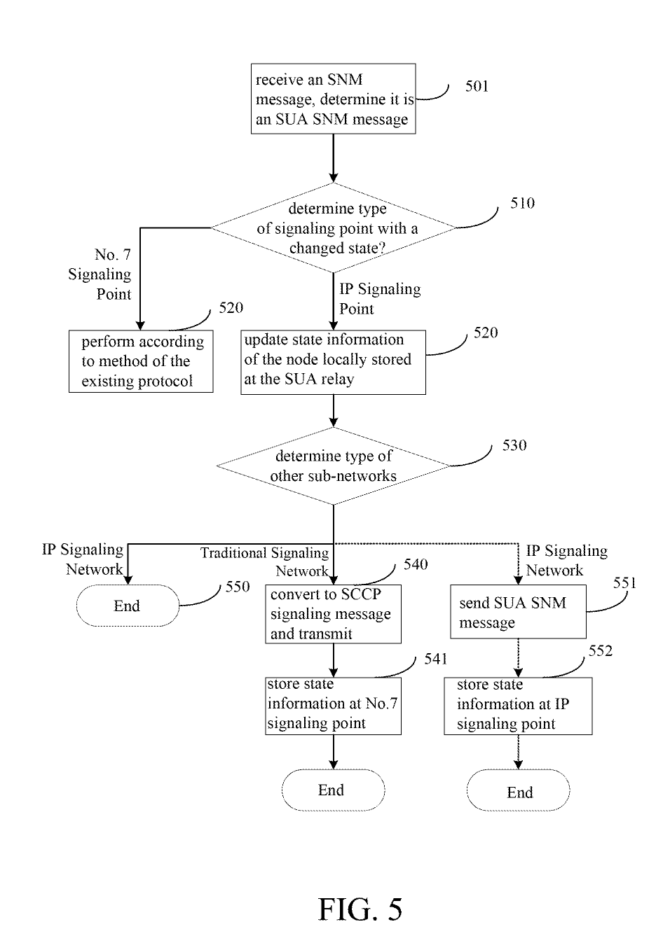

Referring to FIG. 5, the process of transmitting an SUA signaling network management message in an embodiment of the present disclosure is disclosed. The process includes the following blocks.

Block 501: A signaling network management (SNM) message sent from a sub-network is received at the first SUA relay, and the signaling network management message is determined to be an SUA signaling network management message.

Block 510: At the first SUA relay, the type of the network signaling point with a changed state is determined based on the address information in the SUA signaling network management message.

The SUA signaling network management message received by the first SUA relay may be generated by an IP signaling point in the IP signaling network and sent to the first SUA relay, or may be an SUA signaling network management message converted from an SCCP signaling network management message by another SUA relay and sent to the first SUA relay. If the SUA signaling network management message contains the Affected Point Address parameter, it may confirm that the network signaling point with a changed state is an IP signaling point.

As considered in the practical application, the first SUA relay may receive a DAVA message of the existing structure, it then may determine whether it is an IP signaling point or a No. 7 signaling point having a changed state according to the content in the Affected Point Code parameter.

Block 520: If it is determined that the network signaling point with a changed state is an IP signaling point, the state information of the IP signaling point with a changed state is stored locally at the first SUA relay according to the SUA signaling network management message.

The IP signaling point may be an IPV4 signaling point, an IPV6 signaling point or a hostname. It may learn what kind of change occurs to the state of the IP signaling point state by utilizing the type of the SUA signaling network management message. For example, the message DUNA represents that the destination is unavailable, the message DUPU represents that the destination user part is unavailable, the message SCON represents that the destination is congested, and the DRST represents that the destination is restricted, etc. It may learn which IP signaling point is the one with a changed state according to the Affected Point Address parameter in the SUA signaling network management message.

Block 530: The types of the other sub-networks connected with the first SUA relay are determined.

Block 540: Upon the determination that one of the other sub-networks is a traditional telecommunication signaling network, the SUA signaling network management message is converted into an SCCP signaling network management message and sent to the No. 7 signaling points in the traditional telecommunication signaling network.

The No. 7 signaling points used to receive the changed state information of the IP signaling point with a changed state may be all the No. 7 signaling points in the traditional telecommunication signaling network, or the No. 7 signaling points in the traditional telecommunication signaling network associated with the IP signaling point with a changed state, e.g., a No. 7 signaling point that will route to the IP signaling point with a changed state.

The conversion of the SUA signaling network management message into the SCCP signaling network management message includes:

obtaining the address information of the IP signaling point with a changed state from the SUA signaling network management message, and converting the address information into a form recognizable in the traditional telecommunication signaling network;

generating the SCCP signaling network management message of the corresponding type according to the type of the SUA signaling network management message; and

adding the address information of the converted form into the SCCP signaling network management message.

Corresponding to the foregoing several SUA signaling network management messages, the SCCP signaling network management messages may be classified into several different types, which has been disclosed by the prior art and will not be described here.

In addition, when the first SUA relay is directly connected with the traditional telecommunication signaling network, the SUA signaling network management message is converted into the SCCP signaling network management message by the first SUA relay; while the first SUA relay is connected with the traditional telecommunication signaling network via a second SUA relay, the SUA signaling network management message is sent to the second SUA relay and converted into the SCCP signaling network management message by the second SUA relay.

Further, when the first SUA relay is connected with the traditional telecommunication signaling network via the second SUA relay, the changed state information of the IP signaling point with a changed state may be stored locally at the second SUA relay utilizing the SUA signaling network management message.

In the embodiment of the present disclosure, after the SUA signaling network management message sets the IP signaling point address information, the type of the signaling point with a changed state may be discerned effectively, and the SUA signaling network management message indicative of the state changing of the IP signaling point may be converted into a corresponding SCCP signaling network management message, and sent to the No. 7 signaling points within the traditional telecommunication signaling network.

Further, the method may further include the following block after block 540:

block 541: The changed state information of the IP signaling point is stored locally at the No. 7 signaling points utilizing the SCCP signaling network management message.

A signaling network management message will be generated upon the state changing of a signaling point in any sub-network. The SUA signaling network management message may be generated in many ways, one is that the SUA relay generates the SUA signaling network management message upon detecting that the state of a directly connected IP signaling point is changed; another is that the IP signaling point with a changed state generates the SUA signaling network management message itself and transmits the message to the SUA relay; or the SUA relay may converts a received SCCP signaling network management message into the SUA signaling network management message.

Additionally, the method provided by the embodiment of the present disclosure may further include the following blocks after block 530:

Block 550: The process flow is terminated if one of the other sub-networks connected with the first SUA relay is an IP signaling network; or

Block 551: An SUA signaling network management message is sent to the IP signaling points in the IP signaling network; and

Block 552: The changed state information of the IP signaling point with a changed state is stored locally at the IP signaling point.

With the above blocks, the No. 7 signaling points in the traditional telecommunication signaling network would learn the changed state of the IP signaling point with a changed state, and the IP nodes in an IP signaling network may learn the changed state of an IP signaling point in another IP signaling network as well, thereby expanding the applicable scope.

FIG. 4 discloses an application scene of the method for transmitting the SUA signaling network management message in an embodiment of the present disclosure, where the first network 41 is an IP signaling network, the second network 42 is a traditional telecommunication signaling network, the third network 43 is an IP signaling network, the second SUA relay 422 is connected with the second network 42, the second network 42 includes a first No. 7 signaling point 4201 and a second No. 7 signaling point 4202; the first SUA relay 411 is connected with the first network 41 and the third network 43, the first network 41 includes a first IP signaling point 4101 and a second IP signaling point 4102, and the third network 43 includes a third IP signaling point 4303; and the second SUA relay 422 is further connected with the first SUA relay 411.

The methods and relays for transmitting the SUA signaling message provided in the embodiment of the present disclosure are applicable to the situations where the IP signaling network is connected directly with the traditional telecommunication signaling network via the SUA relay (the SUA relay is equivalent to a signaling gateway here) as well as other variants that will be readily conceived by those skilled in the art, in addition to the scene shown in FIG. 4.

Referring to FIG. 4 again, in the application scene disclosed in FIG. 4, the specific application of the method provided by the embodiment of the present disclosure is as follow.

At 401, when the routing state of the first IP signaling point 4101 in the first network 41 becomes available from unavailable, the first IP signaling point 4101 generates a DAVA message, carrying the IP address information of the first IP signaling point 4101.

At 402, the DAVA message is sent to the first SUA relay 411, which determines whether the received message is an SUA signaling gateway message, and determines that the signaling point with a changed state is the first IP signaling point 4101 and that the SUA signaling gateway message is a DAVA message if the received message is an SUA signaling gateway message.

At 403, the changed state information of the first IP signaling point 4101 is stored locally at the first SUA relay 411 utilizing the DAVA message.

According to the prescription of the protocol, the DAVA message itself means that the routing state becomes available from unavailable. In other words, when the first SUA relay 4101 receives a DAVA message, it may learn that the routing state of the first IP signaling point 4101 becomes available from unavailable merely according to the fact that the received SUA signaling network management message is a DAVA message, regardless the specific content of the DAVA message.

At 404, the types of the other sub-networks connected with the first SUA relay 411 are analyzed.

In the particular applications, one SUA relay may be connected with a number of sub-networks. When the SUA relay receives a signaling network management message from one of the sub-networks, the remaining sub-networks of the number of sub-networks may be referred to as the other sub-networks. Here, the other sub-networks connected with the first SUA relay 411 are the second network 42 and the third network 43. After analysis, the first SUA relay 411 may find out that the second network 42 is a traditional telecommunication signaling network, and the third network 43 is an IP signaling network.

At 405, the DAVA message is sent to all the signaling points within the third network 43 and the second network 42, informing the signaling points that the first IP signaling point 4101 is accessible via the first SUA relay 411.

The third IP signaling point 4303 in the third network 43 may not be informed by sending the DAVA message. The message sent from the third IP signaling point 4303 destined to the first IP signaling point 4101 may be routed to the first SUA relay 411, and then arrive at the first IP signaling point 4101 according to the state information stored in the first SUA relay 411.

At 406, because the first SUA relay 411 is connected with the second network 42 via the second SUA relay 422, the DAVA message may be sent to the No. 7 signaling points of the second network 42 through the second SUA relay 422; upon receiving the DAVA message from the first SUA relay 411, the second SUA relay 422 is required to store the changed routing state information of the first IP signaling point 4101 locally, convert the DAVA message into the corresponding SCCP signaling network management message and send it to the first No. 7 signaling point 4201 and the second No. 7 signaling point 4202. In this regard, the first No. 7 signaling point 4201 and the second No. 7 signaling point 4202 may learn the changed state of the first IP signaling point 4101, thereby ensuring that the message from the second network 42 and destined to the first IP signaling point 4101 may be routed to the first SUA relay 411 via the second SUA relay 422, and then arrive at the first IP signaling point 4101.

Blocks 401 to 403 describe generating the DAVA message and storing the changed information of the first IP signaling point 4101 locally at the first SUA relay 411. If the first SUA relay 411 already knows that the first network 41 connected thereto is an IP signaling network, then the blocks 401 to 403 may be as follow.

At 401′, upon detecting that the routing state of the first IP signaling point 4101 becomes available from unavailable, the first SUA relay 411 directly stores the changed state information of the first IP signaling point 4101 locally.

At 402′, the first SUA relay 411 generates a DAVA message, carrying the IP address information of the first IP signaling point 4101.

It is understood that, the method provided in this embodiment is applicable to the DAVA message, as well as other types of SUA signaling network management messages, e.g., the DUNA message indicating that the routing state of an IP signaling point becomes unavailable from available. Take the first IP signaling point 4101 as an example, because it is then not routable between the first IP signaling point 4101 and the first SUA relay 411, the SUA signaling network management message may be generated by the first SUA relay 411.

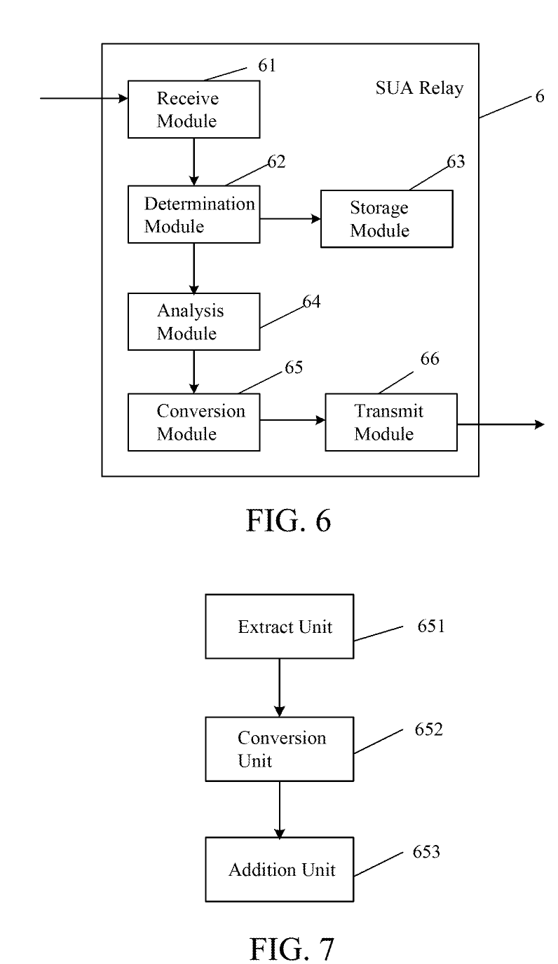

Referring to FIG. 6, the structure of the SUA relay 6 provided in the embodiment of the present disclosure is disclosed. The SUA relay 6 includes a receiving module 61, a determining module 62, a storing module 63, an analyzing module 64, a converting module 65, and a transmitting module 66.

The receiving module 61 is configured to receive the signaling network management message sent from a connected sub-network, wherein the signaling network management message indicates the state changing of the network signaling point with a changed state.

The determining module 62 is configured to determine the type of the signaling network management message received by the receiving module, and determine whether the network signaling point with a changed state is an IP signaling point upon determination that the signaling network management message is an SUA signaling network management message, wherein the IP signaling point may be an IPV4 signaling point, an IPV6 signaling point or a hostname.

The storing module 63 is configured to store the changed state information of the network signaling point with a changed state utilizing the SUA signaling network management message after the determining module 62 determines that the network signaling point with a changed state is an IP signaling point. It should be stated that, although the storing module 63 is optional, most SUA relays generally have the storage function, thus the preferred embodiments usually include the storing module 63.

The analyzing module 64 is configured to analyze whether the sub-networks connected with the SUA relay include a traditional telecommunication signaling network after the determining module 62 determines that the network signaling point with a changed state is an IP signaling point.

The converting module 65 is configured to convert the SUA signaling network management message into an SCCP signaling network management message upon the analyzing module 64 indicates that the sub-networks connected with the SUA relay include at least one traditional telecommunication signaling network.

The transmitting module 66 is configured to transmit the SCCP signaling network management message obtained by the converting module 65 to the No. 7 signaling points in the traditional telecommunication signaling network, upon the analyzing module 64 indicates that the sub-networks connected with the SUA relay include at least one traditional telecommunication signaling network.

As illustrated in FIG. 7, a structure of a first converting module 65 in an embodiment of the present disclosure is illustrated. The first converting module 65 includes:

an extracting unit 651, configured to acquire the address information of the IP signaling point with a changed state from the SUA signaling network management message;

a converting unit 652, configured to convert the address information acquired by the extracting unit 651 into a form recognizable in the traditional telecommunication signaling network, and converting the SUA signaling network management message into an SCCP signaling network management message of the corresponding type; and

an adding unit 653, configured to add the address information with the converted form into the SCCP signaling network management message.

In addition, the SUA relay 6 may further include a selecting module, for determining the No. 7 signaling points to receive the SCCP signaling network management message, and for informing the transmitting module 66.

Although the above embodiments are illustrated by an example of the DAVA message, the methods and apparatuses employed in the above embodiments are applicable for other types of SUA signaling network management messages.

The embodiments of the present disclosure enable transmitting the signaling network management messages from an IP signaling network to a traditional telecommunication signaling network and from an IP signaling network to another IP signaling network by configuring the address information of the IP signaling point in the SUA signaling network management message and by providing the corresponding methods and apparatus for transmitting, thereby significantly expanding the applicable scope, so as to ensure that the related signaling points in other networks may adjust the service traffics timely according to the signaling network management message after the state of a signaling point in an IP signaling network is changed, thereby maintaining the service traffic in the entire network in a proper state.

It is apparent that various modifications and variations may be made to the present disclosure by those skilled in the art without departing from the spirit and scope of the present disclosure. Thus, such modifications and variations of the present disclosure that fall within the scope of the claims of the present disclosure and its equivalent are intended to be embraced within the present disclosure.

1-19. (canceled)

20. A method for transmitting a Signaling Connection Control Part User Adaptation Layer (SUA) signaling network management message, applied in a communication network including an SUA relay device, the method comprising:
receiving an SUA signaling network management message;
determining, according to address information carried in the SUA signaling network management message, a network signaling point with a changed state being an IP signaling point; and
converting the SUA signaling network management message into a corresponding Signaling Connection Control Part (SCCP) signaling network management message and transmitting the SCCP signaling network management message to a No. 7 signaling point in a traditional telecommunication signaling network, when it is determined that the sub-networks communicating with the SUA relay device comprise the traditional telecommunication signaling network.

21. The method of claim 20, wherein, before the process of converting the SUA signaling network management message into a corresponding SCCP signaling network management message, the method further comprises:
storing state information of the IP signaling point with the changed state locally at the SUA relay device according to the SUA signaling network management message.

22. The method of claim 20, wherein, the process of transmitting the SCCP signaling network management message to a No. 7 signaling point in the traditional telecommunication signaling network comprises:
sending the SCCP signaling network management message to all No. 7 signaling points in the traditional telecommunication signaling network; or
sending the SCCP signaling network management message to a No. 7 signaling point which is associated with the IP signaling point with the changed state and in the traditional telecommunication signaling network.

23. The method of claim 20, wherein, the process of converting the SUA signaling network management message into a corresponding SCCP signaling network management message comprises:
acquiring the address information of the IP signaling point with the changed state from the SUA signaling network management message, and converting the address information into a form recognizable in the traditional telecommunication signaling network;
generating the SCCP signaling network management message of a corresponding type according to the type of the SUA signaling network management message; and
adding the address information in the converted form into the SCCP signaling network management message.

24. The method of claim 20, wherein, after the process of sending the SCCP signaling network management message to a No. 7 signaling point in the traditional telecommunication signaling network, the method further comprises:
storing, locally at the No. 7 signaling point, changed state information of the IP signaling point according to the SCCP signaling network management message.

25. The method of claim 20, wherein, if the sub-networks communicating with the SUA relay device further comprise an IP signaling network, the method further comprises:
sending the SUA signaling network management message to an IP signaling point in the IP signaling network; and
storing, locally at the IP signaling point, state information of the IP signaling point with the changed state.

26. The method of claim 20, wherein, the process of receiving an SUA signaling network management message comprises:
receiving an SUA signaling network management message sent from a first sub-network, wherein the SUA signaling network management message is generated and transmitted by an IP signaling point with a changed state and in the first sub-network; or
receiving an SUA signaling network management message sent from an earlier SUA relay device.

27. The method of claim 20, wherein, the address information is an IP signaling point address parameter, which is used to represent the address information of the IP signaling point with the changed state.

28. The method of claim 20, wherein, the SUA signaling network management message includes one of a Destination Available (DAVA), Destination Unavailable (DUNA), Signaling Congestion (SCON), Destination User Part Unavailable (DUPU), and Destination Restricted (DRST) message.

29. A Signaling Connection Control Part User Adaptation Layer (SUA) relay device, comprising:
a receiving module, configured to receive an SUA signaling network management message, wherein the SUA signaling network management message indicates a state changing of a network signaling point with a changed state;
a determining module configured to determine whether the network signaling point with the changed state is an IP signaling point according to address information carried in the SUA signaling network management message;
an analyzing module configured to determine whether sub-networks communicating with the SUA relay device include a traditional telecommunication signaling network;
a converting module configured to convert the SUA signaling network management message into a corresponding Signaling Connection Control Part (SCCP) signaling network management message if the sub-networks communicating with the SUA relay device include a traditional telecommunication signaling network; and
a transmitting module configured to forward the corresponding SCCP signaling network management message to a No. 7 signaling point in the traditional telecommunication signaling network.

30. The SUA relay device of claim 29, further comprising:
a storing module, configured to store state information of the IP signaling point with the changed state according to the SUA signaling network management message.

31. The SUA relay device of claim 29, wherein, the converting module comprises:
an extracting unit configured to acquire the address information of the IP signaling point with the changed state from the SUA signaling network management message;
a converting unit configured to convert the address information acquired by the extracting unit into a form recognizable in the traditional telecommunication signaling network, and convert the SUA signaling network management message into the SCCP signaling network management message of a corresponding type; and
an adding unit configured to add the address information in the converted form into the SCCP signaling network management message.

32. The SUA relay device of claim 29, further comprising:
a selecting module, configured to determine the No. 7 signaling point to receive the SCCP signaling network management message, and inform the transmitting module.

33. The SUA relay device of claim 29, wherein the receiving module is configured to:
receive an SUA signaling network management message sent from a first sub-network, wherein the SUA signaling network management message is generated and transmitted by an IP signaling point with a changed state and in the first sub-network; or
receive an SUA signaling network management message sent from an earlier SUA relay device.

34. A Signaling Connection Control Part User Adaptation Layer (SUA) relay device, comprising:
a receiving module configured to receive a signaling network management message, wherein the signaling network management message indicates a state change of a network signaling point with a changed state;
a determining module configured to determine, if the signaling network management message is an SUA signaling network management message, whether the network signaling point with the changed state is an IP signaling point according to address information carried in the SUA signaling network management message;
an analyzing module configured to determine whether sub-networks communicating with the SUA relay device include a traditional telecommunication signaling network;
a converting module configured to convert the SUA signaling network management message into a corresponding Signaling Connection Control Part (SCCP) signaling network management message if the sub-networks communicating with the SUA relay device include a traditional telecommunication signaling network; and
a transmitting module configured to forward the corresponding SCCP signaling network management message to a No. 7 signaling point in the traditional telecommunication signaling network.

35. The SUA relay device of claim 34, further comprising:
a storing module configured to store state information of the IP signaling point with the changed state according to the signaling network management message if the signaling network management message is an SUA signaling network management message.

36. A communication network, comprising a traditional telecommunication signaling network and an IP signaling network, wherein the communication network further comprises at least one SUA relay device,
wherein a second SUA relay device is configured to receive an SUA signaling network management message sent from the IP signaling network or from a first SUA relay device, determine that a network signaling point with a changed state is an IP signaling point according to address information carried in the SUA signaling network management message, convert the SUA signaling network management message into a corresponding Signaling Connection Control Part (SCCP) signaling network management message and transmit the corresponding SCCP signaling network management message to a No. 7 signaling point in the traditional telecommunication signaling network.
